(19) United States
(12) Patent Application Publication
(10) Pub. No.: US 2024/0376354 A1
(43) Pub. Date: Nov. 14, 2024

(54) Liquid Reinforcing Adhesives

(71) Applicant: Zephyros, Inc., Romeo, MI (US)

(72) Inventor: Vincent Goldman, Romeo, MI (US)

(21) Appl. No.: 18/686,947

(22) PCT Filed: Sep. 1, 2022
(86) PCT No.: PCT/US2022/042316

§ 371 Date: Feb. 27, 2024

Related U.S. Application Data
(60) Provisional application No. 63/239,821, filed on Sep. 1, 2021.

(51) Int. Cl. C09J 163/00; C09J 11/04; C09J 11/06

(52) U.S. Cl. CPC C09J 163/00; C09J 11/04; C09J 11/06

(57) ABSTRACT

A composition comprising a two-component liquid reinforcing adhesive comprising a first part having at least one epoxide functional constituent, an optional foaming agent, and a particulate filler and a second part having at least one acidic phosphorus containing curing agent.

### TECHNICAL FIELD

The present teachings relate generally to a two-component liquid reinforcing system that has at least one epoxide functional constituent on one side and at least one acidic phosphorus containing curing agent on the other side as well as its use in reinforcing thin gauge sheet metal and other thin light-weight structures. The feature of being a liquid applied material using an acidic phosphorus curing system removes the variability in application which leads to inconsistent performance in manually applied reinforcing patches as well as addressing issues with adhesion to oiled substrates pre and post bake, read through and corrosion resistance. It also reduces manufacturing complexity and waste associated with state-of-the-art die cut multi-layered reinforcing patches.

### BACKGROUND

To further promote higher fuel economy, the automotive industry continually looks for opportunities to reduce the weight of the vehicles being produced. One strategy towards this light-weighting has been to reduce the gauge of sheet metal in areas including, doors, sliding doors, tailgates, and truck bed sides from about 1.2 mm to about 0.7 mm in thickness. Reinforcing patches are commonly used to meet local stiffness requirements in certain areas of the vehicle. These reinforcing patches are in doors, particularly around door handles, hoods, trucks, and quarter panels. These patches prevent deformation of the sheet metal including dents, waves, ‘oil canning’ and other undesirable alterations to the exterior surface of the vehicle. Reinforcing of key areas while minimizing additional weight gain often requires patches of complex shapes.

Reinforcing patches for panel reinforcement are typically of a multi-layer construction consisting of a layer of thermosetting adhesive together with a non-reacting reinforcing layer. The adhesive can be any thermosetting adhesive that provides sufficient uncured (green) state adhesion. Further, the adhesive must avoid sag/slide during expansion and cure, as any sagging could cause exposure of bare, untreated metal and thus undesirable corrosion resistance. The adhesive should further have sufficient cured properties such as high stiffness. The thermosetting layer is often laminated to the reinforcing layer to achieve necessary reinforcing properties. Adhesives with foaming capabilities are particularly desirable given that the cured thickness increases the cross-sectional moment of inertia and ultimately decreases both temporary and permanent deflection of the panel caused by external forces. The reinforcing layer is generally composed of an inert non-curing material, typically a woven fiberglass fabric or mesh. The glass fabric or mesh can present challenges by making the patch material difficult to cut. In addition, scrap material from the cutting of complex shapes can be very difficult to recover for reuse. There is also the cost of creating and maintaining dies needed to cut patches of various shapes and thicknesses.

Epoxy-based adhesives are often utilized due to their durable adhesion to metal and high elastic modulus. The reinforcing layer can be metal, glass or thermoplastic sheets to name a few. However, glass fibers tend to give the highest stiffness for the panel stiffener, while maintaining conformability prior to cure of the adhesive.

One component pumpable adhesives compromise green state adhesion/wash off performance because of the process viscosity they need in order to be pumped and applied. Also, they rely on elevated temperature cure and are more prone to read through.

The present teachings overcome current concerns with manufacturing, production, application, and performance of patches by providing a low viscosity liquid pumpable reinforcing adhesive for use in reinforcement of thin gauge sheet metal and thin-walled composite panels. There is no waste such as that associated with the production and application of dual layer patches namely offal that cannot be recycled and release paper and boxes used in the production process. There is also the elimination of creating and maintaining dies needed to cut complex patch geometries. The present teachings also overcome the variability in performance of dual layer patches that must be manually applied. The problems that occur with placement and pressure when applying dual layer patches include poor adhesion pre and post bake and poor corrosion resistance. The two-component liquid reinforcing adhesive cures sufficiently at room temperature to ensure adhesion to for instance oiled substrates so that it can withstand exposure to an automotive phosphating and e-coat process prior to being fully cured. The dispensed material can be dispensed in any pattern without waste to take advantage of computer modeling. The two-component liquid reinforcing adhesive which cure at room temperature also demonstrate much reduced read through or distortion of the substrate after baking compared to traditional patches which cure entirely at elevated temperatures.

### SUMMARY OF THE INVENTION

The teachings herein contemplate a liquid two-component (A-side, B-side) reinforcing adhesive and method for the structural reinforcement of metallic and composite panels and stampings with a liquid reinforcing adhesive. The liquid reinforcing adhesive may be mixed and dispensed onto horizontal and vertical surfaces without sagging or pooling. Because it is not a multi-layered patch, there is no waste in manufacturing in the form of offal and release paper. There is no cost in the creation and maintenance of dies needed to cut complex patch geometries. The material can be robotically dispensed as to avoid the pitfalls of performance variability associated with patches that are manually applied, namely poor adhesion pre and post bake and corrosion resistance. There is also elimination of read through as a result of immediate commencement of curing that occurs with the liquid reinforcing adhesive after it is dispensed. This greatly reduces the stresses encountered in curing ovens compared to patches that cure entirely at elevated temperatures.

The present teachings meet one of more present needs by providing a liquid reinforcing adhesive for panel stiffening that is robotically or manually applied.

The liquid reinforcing adhesive according to the invention is a two-component liquid reinforcing adhesive. It comprises a first part A (A-side) and a second part B (B-side).

First part A comprises (i) at least one epoxide functional constituent, (ii) a foaming agent, and (iii) a particulate filler. Second part B comprises (i) at least one acidic phosphorus containing curing agent.

The liquid reinforcing adhesive according to the invention, i.e., first part A and/or second part B, may further include one or more toughening agents, one or more reinforcing particulates, one or more multi-functional epoxies, one or more thixotropic agents, or any combinations thereof.

The liquid reinforcing adhesive may contain a foaming agent and thus may be foamable.

The liquid reinforcing adhesive may have a vertical expansion of from about 0 to 3 times its initial height in the dispensed state. The liquid reinforcing adhesive may have a vertical rise from about 100-200%. The ratio of initial thickness to post cure thickness of the liquid applied adhesive is preferably from about 1:1 to about 1:4. The liquid reinforcing adhesive may have an initial thickness from about 1-3 mm. The liquid reinforcing adhesive may have a post-cure thickness of from about 1-6 mm.

The liquid reinforcing adhesive may not be flexible after activation. The liquid reinforcing adhesive may be rigid after activation. The liquid reinforcing adhesive may have a peak load greater than 80 N when applied to for example 0.7 mm thick steel, preferably determined in accordance with ASTM D-790-03. The liquid reinforcing adhesive may have an extension to break of about 3 mm, preferably determined in accordance with ASTM D-790-03.

The liquid reinforcing adhesive contains a particulate filler. The liquid reinforcing adhesive may include one or more reinforcing particulates. The liquid reinforcing adhesive may include about 10-20% by weight of one or more acicular particles of discontinuous fibers, relative to the total weight of the liquid reinforcing adhesive. The liquid reinforcing adhesive may include at least 20% by weight reinforcing particulate, relative to the total weight of the liquid reinforcing adhesive. The reinforcing particulate may be wollastonite. The reinforcing particulate may increase the elastic modulus of the liquid reinforcing adhesive.

The liquid reinforcing adhesive contains at least one epoxide functional constituent. The liquid reinforcing adhesive may include a liquid epoxy resin and a multifunctional epoxy resin.

The teachings herein further contemplate a method for stiffening a vehicle body stamping comprising mixing and robotically/manually dispensing a two-component liquid reinforcing adhesive onto a desired location. The liquid reinforcing adhesive may cure after being dispensed.

The method may include exposing the liquid reinforcing adhesive to elevated temperatures during for example the E-coating and painting processes which further cure the liquid reinforcing adhesive. The method may include foaming the reinforcing adhesive with a metal carbonate to provide a vertical rise (e.g., height or thickness) of from about 10% to about 300% as compared to the original dispensing height.

The teachings herein are further directed to a two-component liquid reinforcing adhesive comprising a first part A comprising at least one epoxide functional constituent; an optional foaming agent; and a reinforcing particulate; a second part B comprising at least one acidic phosphorus containing curing agent.

The reinforcing particulate may have an aspect ratio of greater than 2. The reinforcing particulate may be selected from carbon black; precipitated silica; precipitated calcium carbonate; fumed silica; talc; clay such as kaolinite, montmorillonite, and sepiolite; micas such as phlogopite and muscovite; wollastonite; and mixtures thereof. The content of the reinforcing particulate is greater than 25% by weight, preferably greater that 30% by weight of the total liquid reinforcing adhesive formulation.

The at least one acidic phosphorus containing curing agent may contain phosphoric acid. The at least one epoxide functional constituent may comprise a liquid epoxy resin, a reactive epoxy diluent, a multifunctional epoxy resin, or any mixture thereof. The foaming agent may be a metal carbonate.

The adhesive may include a toughening agent. The toughening agent may contain an epoxidized rubber.

The adhesive when mixed and cured demonstrates low read through. The adhesive when mixed and cured demonstrates adhesion to oiled steel. The adhesive when mixed and cured demonstrates continued adhesion when exposed to salt spray.

The adhesive may include a polybutadiene component in an amount of at least 5% by weight, or even at least 10% by weight. The adhesive may include a biphenyl aralkyl epoxy resin component in an amount of at least 5% by weight, or even at least 10% by weight. The adhesive may include a tetrafunctional epoxy resin.

The adhesive may include calcium carbonate, potassium carbonate, zinc carbonate, sodium bicarbonate, or some combination thereof. The adhesive may include free phosphoric acid in an amount of at least 2% by weight.

The adhesive may include at least two phosphate ester components. Thee adhesive may include an organophilic phyllosilicate-based component in both part A and part B. The adhesive may include an adducted carboxyl terminated polymer in an amount of at least 0.5% by weight, or even at least 1% by weight.

The adhesive may include one or more phosphate ester components selected from: a phosphate ester derived from cashew nutshell liquid (CNSL), a phosphate ester derived from 2-ethylhexyl glycidyl ether; a phosphate ester derived from phenyl glycidyl ether, a phosphate ester derived from an epoxidized para-tertiary butyl phenol, a nonyl phenol ethoxylated phosphate ester, or some combination thereof.

The adhesive may include at least two phosphate ester components, a biphenyl aralkyl epoxy resin component, a polybutadiene component, and a tetrafunctional epoxy resin component. The adhesive may include at least two phosphate ester components, a biphenyl aralkyl epoxy resin component in an amount of at least 5% by weight, a polybutadiene component in an amount of at least 5% by weight, and a tetrafunctional epoxy resin component in an amount of at least 2%.

The teachings herein are also directed to a vehicle panel reinforcement comprising an adhesive including a first component and a second component, the first component including a reinforcing particulate and the second component including at least one at least one acidic phosphorus containing curing agent, wherein the adhesive is liquid at 23° C.

The vehicle reinforcement may be free of any carrier or other solid material. The reinforcement may be adapted for application to the vehicle panel either before or after an electrocoating process. The adhesive may foam. The vehicle panel may be substantially free of any read-through after foaming and curing of the adhesive.

The adhesive may include one or more of at least two phosphate ester components, a biphenyl aralkyl epoxy resin component, a polybutadiene component, and a tetrafunctional epoxy resin component. The adhesive may include a reinforcing particulate in an amount greater than 25% by weight, preferably greater that 30% by weight of the total adhesive formulation.

The teachings herein may include a method comprising applying the adhesive to a vehicle panel prior to or after an electrocoating process.

The teachings herein may further be directed to a vehicle panel comprising a metallic or composite panel, and an adhesive layer in direct planar contact with the panel, wherein the adhesive layer is free of any carrier or solid material layer.

### BRIEF DESCRIPTION OF THE DRAWINGS

FIG. 1 shows images of an adhesive and substrate demonstrating improved cohesive failure and an adhesive and substrate demonstrating no cohesive failure.

FIG. 2 shows the cold slam fixture utilized for the testing of example 2.

FIGS. 3A and 3B show two opposing sides of a substrate displaying no read-through of the adhesive.

FIGS. 4A and 4B show two different substrates with the adhesive removed and no evidence of corrosion.

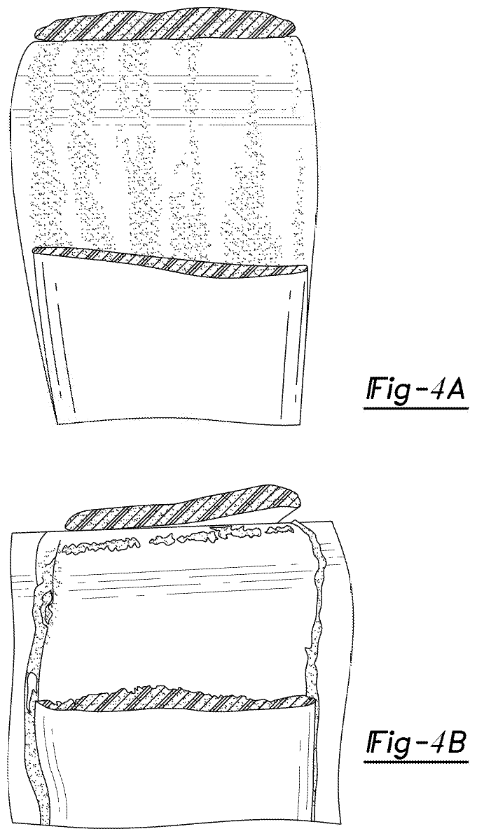

### DETAILED DESCRIPTION

The present teachings meet one or more of the above needs by the improved processes and materials described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the priority date if U.S. Provisional Application No. 63/239,821, filed on Sep. 1, 2021, the entirety of the contents of that application being hereby incorporated by reference herein for all purposes.

The present teachings generally provide for a liquid reinforcing adhesive for panels (e.g., automotive body panels, tail gates, etc.). The liquid reinforcing adhesive may be fabric free (e.g., free of any reinforcing layer/carrier/solid material layer). The liquid reinforcing adhesive may be free of any reinforcing layer which eliminates waste associated with patches that contain them. The liquid reinforcing adhesive may include one or more reinforcing particulates, e.g., wollastonite, in combination with one or more discontinuous fiber components, e.g., one or more acicular particles of discontinuous fibers, to obtain stiffness comparable to traditional patches which include a reinforcing layer.

The liquid reinforcing adhesive may be formulated to cure partially or fully (e.g., prior to heat activation) which enable it to immediately adhere in various conditions included among these is contact with heat, cold, and humidity in a manufacturing plant and in a paint bake oven. In addition, the surfaces of vehicle cavities are typically coated with one or more lubricants presenting significant challenges to adhesion. Lastly, most vehicles are subject to an electro coat (E-coat) process including cleaning steps which may cause the reinforcing patch to wash-off the panel and contaminate the E-coat bath. Thus, the liquid reinforcing adhesives described herein may adhere sufficiently because once dispensed have intimate contact with the substrate and begin to cure immediately further promoting adhesion. The liquid reinforcing adhesive described herein may be particularly well suited for adhesion to a variety of materials, including metals such as steel and aluminum commonly utilized in vehicle manufacture.

The liquid reinforcing adhesive may exhibit reinforcement characteristics (e.g., imparts rigidity/stiffness), strength or a combination thereof to a member. The liquid reinforcing adhesive may be heat activated to foam or otherwise activate and wet surfaces (upon exposure to heat) which the liquid reinforcing adhesive contacts. The liquid reinforcing adhesive may also cure partially or fully at room temperature. The reinforcing adhesive, after cure, may have a volumetric expansion of about 0 vol %, about 100 vol %, about 300 vol %, or even more. The liquid reinforcing adhesive may have a vertical height increase of about 0 time to about 3 times the initial height (e.g., thickness) of the liquid reinforcing adhesive in its green state. After expansion or activation, the reinforcing adhesive may cure, harden, and continue to adhere to the surfaces that it contacts.

For example, and without limitation, a liquid reinforcing adhesive will include a polymeric material, typically at least one epoxide functional constituent such as an epoxy resin, when combined with appropriate ingredients (typically a foaming agent, a particulate filler, and an acidic phosphorus containing curing agent), foams and cures in a reliable and predictable manner upon the application of heat or the occurrence of a particular ambient condition. From a chemical standpoint for a thermally activated material, the liquid reinforcing adhesive may be initially processed as a flowable material before curing. Thereafter, the base material may cross-link upon curing, which makes the material substantially incapable of further flow.

The epoxy functional group containing systems of the current teachings may include at least one epoxide functional constituent (as comprised in first part A) and curing agents composed of acidic phosphorus materials, i.e., at least one acidic phosphorus containing curing agent (as comprised in second part B).

Preferred epoxide functional constituents include liquid epoxy resins, reactive diluents, multifunctional epoxy resins, and combinations thereof. Suitable liquid epoxy resins include but are not limited to D.E.R.® 331 and Kukdo EPOKUKDO® YDF 170. Suitable reactive diluents include but are not limited to Cardolite® NC 514S. Suitable multifunctional epoxy resins include but are not limited to Epalloy® 8250, D.E.N.® 426, GE 60, and Epotec® YDM 441.

The at least one acidic phosphorus containing curing agent may be obtained from the reaction of epoxide groups with phosphoric acid as depicted below:

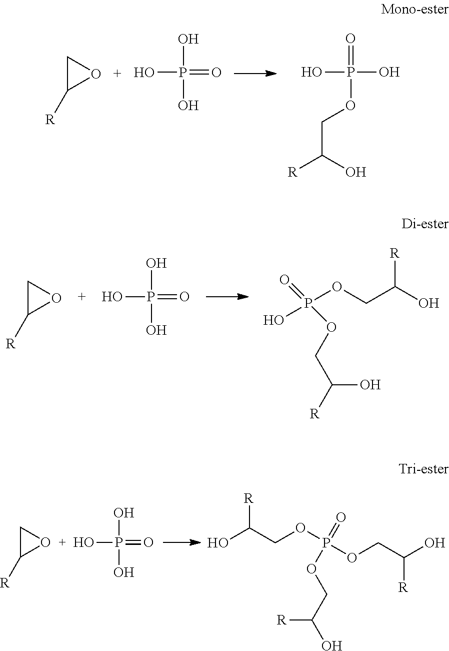

The B-side may comprise one or more acids. The acid may be liquid at room temperature. Room temperature, as referred to herein, may mean a temperature of between about 20° C. and 25° C. The acid may have a pH of less than 7. The acid may comprise phosphate ester, phosphoric acid, citric acid, acetic acid, or any acid that is stable when mixed with phosphoric acid or phosphate esters. The acid may comprise at least phosphate ester and optionally phosphoric acid, citric acid, acetic acid, or any combination thereof. Phosphoric acid acts as a tri-functional addition reactant and a homopolymerization catalyst. Small changes in the amount of phosphoric acids used may result in large differences in performance. Without sufficient cross link density, systems will become brittle as the network lacks sufficient molecular weight to withstand flexural forces.

The B-side may include phosphorous pentoxide (P2O5) which is an anhydride of phosphoric acid. This white crystalline solid could react with water or moisture, generate excessive heat, and turn to phosphoric acid. The reaction is very rapid and highly exothermic. The phosphoric acid then could react with the epoxide groups or metal carbonates from the A-side. This material helps with two of the mechanisms that we are interested in. Absorbing and reacting with water and also generating heat to evaporate water from the substrate.

The B-side may comprise one or more phosphate esters, phosphate ester precursors, or both. The one or more phosphate esters may be pre-reacted. The B-side may comprise one or more phosphate ester precursors that may be combined with phosphoric acid prior to combination with the A-side.

The B-side may include additional phosphoric acid. The additional phosphoric acid may include ortho-phosphoric acid, polyphosphoric acid, or both. The additional phosphoric acid may increase the crosslink density and shorten the reaction time. Reaction speed of the pre-reacted phosphate esters may be increased by the addition of the additional phosphoric acid in the B-side. The additional phosphoric acid may increase foaming of the mixed composition.

The one or more phosphate esters may include a phosphate ester derived from cashew nutshell liquid (CNSL). The one or more phosphate esters may include a phosphate ester derived from 2-ethylhexyl glycidyl ether. The one or more phosphate esters includes a phosphate ester may be derived from phenyl glycidyl ether. The one or more phosphate esters may include a phosphate ester derived from an epoxidized para-tertiary butyl phenol. The one or more phosphate esters may include a nonyl phenol ethoxylated phosphate ester.

The reinforcing adhesive of the present teachings may contain a high weight percentage of a particulate filler, preferably comprising reinforcing particulate. One preferred characteristic of some reinforcing particulates is an aspect ratio of greater than 1, preferably greater than 2. Aspect ratio is defined as the ratio of the largest dimension of the particulate particle divided by the smallest dimension of the particulate particle. High aspect ratio particulates include particulates with particle shapes such as flakes, platelets, rods, needles, rectangles. Particulate materials with high aspect ratios include talc, some clays such as kaolinite, montmorillonite, and sepiolite, micas such as phlogopite and muscovite and wollastonite. The particulate may be a wollastonite material with and aspect ratio of 3-4 or higher. The particulate may be a phlogopite mica with and aspect ratio of 30-40 or higher. For the wollastonite, phlogopite, or muscovite the filler level may be greater than 25% by weight and more preferably greater that 30% by weight of the total liquid reinforcing adhesive formulation. The purpose of these fillers may be to increase the elastic modulus of the polymeric matrix material.

Another characteristic of some reinforcing particulates is a high surface area to volume ratio of the particulate. This is achieved by having a high aspect ratio or by having a very small particle size (e.g., about 20 nm to about 1000 nm or less than about 4 microns). For example, if mica is selected as a reinforcing particulate, the aspect ratio may be at least about 40 (e.g., from at least 40 to about 100). If wollastonite is utilized, the aspect ratio be at least about 3 (e.g., from about 3 to about 20). Reinforcing particulates of such very small size include carbon black, precipitated silica, precipitated calcium carbonate and fumed silica (e.g., Cab-O-Sil® TS 720, Aerosil® R208, Nyglos® 8, or Vansil® HR2000). Such particulates are suitable for use in the current teachings alone or in combination with a high aspect ratio particulate.

When employed, the reinforcing particulates in the liquid reinforcing adhesive can range from about 10% or less to about 90% or greater, from about 25% to about 55%, or even 30% to about 45% by weight of the liquid reinforcing adhesive, preferably for forming a patch. Powdered (e.g., about 0.01 to about 50 micron, about 1 to 25 micron mean particle diameter) mineral type particulate can comprise between about 5% or less to about 70% or greater by weight, or even about 10% to about 50% by weight may be present in the liquid reinforcing adhesive.

The reinforcing adhesive of the present teachings may contain a high weight percentage of a particulate filler, preferably comprising discontinuous fiber components.

The one or more particulates along with the one or more discontinuous fiber components may provide exceptional rigidity and may increase overall stiffness after activation while allowing the reinforcement to be cut into small shapes, complex shapes, or both while maintaining the ability to reprocess the reinforcing material. Absent the discontinuous fiber component, the material may maintain its stiffness at low displacement, but a high extension before breaking and a high peak load may not be achieved.

The reinforcing adhesive of the present teachings contains a foaming agent in the first part A. The liquid reinforcing adhesive (or a self-adhering patch made therefrom) may foam upon heating and curing to about 1 to 3 times its original thickness, or even to about two times its original thickness. The system can employ metal carbonates as foaming agents by reaction with the at least one acidic phosphorus containing curing agent, e.g., with phosphoric acid or other acids from the curing agent to form foams.

The reinforcing adhesive of the present teachings optionally may contain other additives such as modifiers, toughening agents, impact modifiers, and pigments.

Optionally an impact modifier may be added. The impact modifier may be in the form of a core-shell particle consisting of a soft rubber core material and harder outer shell that is more compatible with epoxy functional systems of the current teachings. The core-shell particles may be non-agglomerated in epoxy resin and available under the trade name KaneAce and available from Kaneka Texas Corporation, e.g., Kane Ace® MX-257 or Kane Ace® MX-962.

Suitable toughening agents may include adducted carboxyl terminated polymers such as Epoxonic® 328 Adduct. Another class of toughening agent may be in the form of an epoxidized poly butadiene polymer and available under the trade name Poly BD and available from Cray Valley.

The liquid reinforcing adhesive, when fully cured, may have a modulus of elasticity of from about near zero to about 20 GPa, preferably determined in accordance with ASTM D-790-03. The liquid reinforcing adhesive (or a self-adhering reinforcing patch made therefrom) may have a modulus of elasticity of from about 2 to about 12 GPa. The modulus of elasticity may be >2 GPa, or even >3 GPa with the modulus of elasticity accentuated by addition of particulate matter of fibers.

The liquid reinforcing adhesive of the present teachings can be compounded in a batch process. Suitable equipment for a batch mixing process include planetary mixers, HSD mixers, double arm mixers, and the like.

The two components of the liquid reinforcing adhesive may be mixed for example by static, dynamic, or impingement mixers. The liquid reinforcing adhesive may be dispensed for example in a bead fashion at varying widths or swirl sprayed.

The following materials are used in the examples:

| | | | |
|---|---|---|---|
| D.E.R. ® 331 | epoxide functional | liquid epoxy resin | bisphenol A |
| | constituent | | glycidylether |
| YDF 170 (Kukdo | epoxide functional | liquid epoxy resin | bisphenol F epoxy |
| EPOKUKDO ®) | constituent | | resin |
| NC 514S (Cardolite ®) | epoxide functional | liquid epoxy resin, | diglycidyl ether epoxy |
| | constituent | reactive diluent | resin |
| Epalloy ® 8250 | epoxide functional | multifunctional epoxy | epoxy phenol |
| | constituent | resin | novolac resin |
| D.E.N. ® 426 | epoxide functional | multifunctional epoxy | epoxy novolac resin |
| | constituent | resin | |
| GE 60 | epoxide functional | multifunctional epoxy | 4 functional epoxy |
| | constituent | resin | diluent |
| Epotec ® YDM 441 | epoxide functional | multifunctional epoxy | 4 functional epoxy |
| | constituent | resin | diluent |
| Kane Ace ® MX-257 | impact modifier | core-shell particle | |
| Kane Ace ® MX-962 | impact modifier | core-shell particle | |
| Epoxonic ® 328 | toughening agent | epoxy/elastomer | adducted carboxyl |
| Adduct | | adduct | terminated polymer |
| PolyBD ® 605E | toughening agent | multifunctional epoxy | multifunctional, |
| | | resin | hydroxy terminated, |
| | | | epoxidized |
| | | | polybutadiene resin |
| Q 2 | particulate filler | reinforcing particulate | calcium carbonate |
| Q 200 | particulate filler | reinforcing particulate | calcium carbonate |
| Q 325 | particulate filler | reinforcing particulate | calcium carbonate |
| TS 720 (Cab-O-Sil ®) | particulate filler | reinforcing particulate | fumed silica |
| Aerosil ® R208 | particulate filler | reinforcing particulate | hydrophobic fumed |
| | | | silica |
| Nyglos ® 8 | particulate filler | reinforcing particulate | wollastonite |
| Vansil ® HR2000 | particulate filler | reinforcing particulate | wollastonite with |
| | | | high aspect ratio |
| PE-01 | acidic phosphorus | phosphate ester | Cashew nut shell |
| | containing curing | | liquid -based |
| | agent | | phosphate ester |
| PE-03 | acidic phosphorus | phosphate ester | Phenyl glycidyl |
| | containing curing | | ether-based |
| | agent | | phosphate ester |
| PA | acidic phosphorus | phosphoric acid | |
| | containing curing | | |
| | agent | | |
| Garamite ® 1958 | | | organophilic |
| | | | phyllosilicates, |
| | | | powdered rheology |
| | | | additive |
| KSE 3060 | epoxide functional | | biphenyl aralkyl |
| | constituent | | epoxy resin |

### Example 1

The formulations in this example are prepared by mixing the respective A and B components in a speed mixer under vacuum, filling cartridges, conditioning material to 35° C. and dispensing material through static mixers affixed with a fan tip with a width of 1.5 inches.

The formulations in this example contain epoxy resins, diluents, toughening agents, reinforcing fillers, thixotropes, acidic phosphorus containing curing agents PA, PE-01 and PE-03.

These formulations are dispensed onto G-60 steel (galvanized steel) that was coated with processing oil, 61MAL-HCL-1. After dispensing, the adhesive sits for one hour at room temperature followed by a 30-minute bake at 325° F.

Adhesion is assessed bending the specimen and examining for cohesive failure.

The formulation with a glycidyl amine diluent, TGMDA or trade name YDM 441 (tetrafunctional epoxy resin) shows cohesive failure while the formulation without TGMDA does not adhere and shows no cohesive failure. The TGMDA may be present in an amount of from about 0.5% to about 10% by weight of the adhesive in its entirety (both Part A and Part B). The TGMDA may be present in an amount of at least 1%, or even at least 2% by weight of the adhesive in its entirety.

Component amounts in the formulation are given as weight percentages of the mixed total.

TABLE 1

| Part A | 016-18-1 | 016-18-2 | 016-18-3 |
|---|---|---|---|
| DER 331 | 9.11 | 8.74 | 8.44 |
| Epalloy 8250 | 20.05 | 19.23 | 18.57 |
| GE 60 | 10.94 | 10.49 | 10.13 |
| Kane Ace MX-257 | 12.15 | 11.66 | 11.26 |
| NC 514S | 0.00 | 5.47 | 5.28 |
| Epoxonic 328 Adduct | 1.82 | 1.75 | 1.69 |
| Q2 | 1.65 | 1.59 | 1.53 |
| Q 200 | 3.30 | 3.16 | 3.06 |
| TS 720 | 0.30 | 0.29 | 0.28 |
| Nyglos 8 | 4.45 | | |
| Vansil HR2000 | 14.58 | 18.26 | 17.63 |
| EpotecYDM 441 | 2.71 | 0.00 | 2.67 |
| total A | 81.07 | 80.64 | 80.54 |
| B Side | | | |
| Part B | 016-14-4 | 016-14-4 | 016-14-4 |
| PE-01 | 3.67 | 3.76 | 3.78 |
| PE-03 | 12.86 | 13.15 | 13.23 |
| PA | 2.20 | 2.26 | 2.27 |
| Garamite 1958 | 0.18 | 0.19 | 0.19 |
| Total B | 18.93 | 19.36 | 19.46 |
| Total A + B | 100.00 | 100.00 | 100.00 |

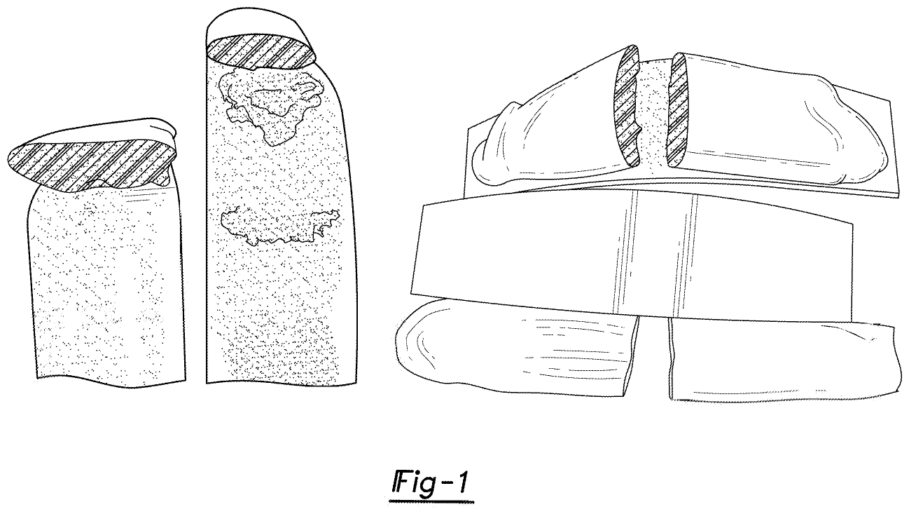

FIG. 1 shows formulas with good cohesive failure, 016-18-1 and 016-18-3 and a formula with no cohesive failure, 016-18-2

### Example 2

Formulations in example 2 are prepared as in example 1 above.

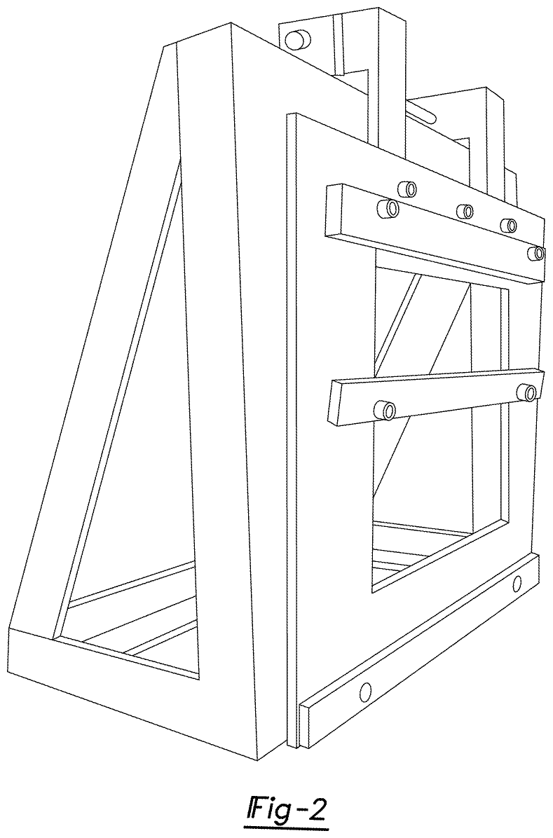

Adhesion is assessed by performing a cold slam test. This test involves freezing prepared specimens (cured adhesive on a specific substrate) at −30° C. for one hour, placing them into a fixture that can be actuated 90 degrees and allowing the fixture with sample to fall freely thereby placing torsional forces on the adhesive. The fixture is actuated and dropped 10 times. Good adhesion is represented by adhesives that can pass 10 slams. Specimens were rated 1-10 with 10 being best. FIG. 2 shows the cold slam fixture used.

Formulations with reduced cross link density also show favorable cold slam performance. The removal of a 4 functional (tetrafunctional) epoxy diluent, GE 60 results in reduced epoxy functionality and improved cold slam performance. The tetrafunctional epoxy diluent may be present in an amount of from about 2% to about 20% by weight of the adhesive in its entirety (both Part A and Part B). The tetrafunctional epoxy diluent may be present in an amount of at least 7%, or even at least 10% by weight of the adhesive in its entirety.

Table 2 provides formulations in weight percent and the associated cold slam performance.

TABLE 2

| Part A | 23-15 | 24-5 |
|---|---|---|
| DER 331 | 8.63 | 8.48 |
| Epalloy 8250 | 18.99 | 29.28 |
| GE 60 | 10.36 | 0.00 |
| Kane Ace MX-257 | 11.51 | 11.54 |
| NC 514S | 2.70 | 2.71 |
| Epoxonic 328 Adduct | 1.73 | 1.73 |
| Q 200 | 4.88 | 4.93 |
| Nyglos 8 | 18.00 | 18.06 |
| EpotecYDM 441 | 3.76 | 3.76 |
| Garamite 1958 | 0.30 | 0.25 |
| Total A | 80.88 | 80.74 |
| B Side | | |
| Part B | 14-4 | 14-4 |
| PE-01 | 3.71 | 3.74 |
| PE-03 | 13.00 | 13.09 |
| PA | 2.23 | 2.24 |
| Garamite 1958 | 0.19 | 0.19 |
| Total B | 19.12 | 19.26 |
| Total A + B | 100 | 100 |
| Cold slam oiled G-60 | 2 | 10 |

### Example 3

Formulations in example 3 are prepared as above in examples 1 and 2.

Adhesion/Cold slam performance is also affected by foaming of the adhesive. Sufficient expansion improves cold slam performance especially on oiled steel.

Table 3 shows formulations in weight percentages along with their associated expansions and cold slam ratings. Formulation 24-5 with a higher expansion than formulation 24-8 demonstrated better cold slam performance. Higher expansion is achieved by increasing metal carbonate content. The metal carbonate may be present in an amount of from about 0.5% to about 20% by weight of the adhesive in its entirety (both Part A and Part B). The metal carbonate may be present in an amount of at least 3%, or even at least 4% by weight of the adhesive in its entirety.

TABLE 3

| Part A | 24-8 | 24-5 |
|---|---|---|
| DER 331 | 8.83 | 8.48 |
| Epalloy 8250 | 30.05 | 29.28 |
| Kane Ace MX-257 | 11.78 | 11.54 |
| NC 514S | 2.76 | 2.71 |
| Epoxonic 328 Adduct | 1.76 | 1.73 |
| Q 200 | 2.79 | 4.93 |
| Nyglos 8 | 18.43 | 18.06 |
| EpotecYDM 441 | 3.85 | 3.76 |
| Garamite 1958 | 0.26 | 0.25 |
| total A | 80.53 | 80.74 |
| B Side | | |
| Part B | 14-4 | 14-4 |
| PE-01 | 3.78 | 3.74 |
| PE-03 | 13.24 | 13.09 |
| PA | 2.27 | 2.24 |
| Garamite 1958 | 0.19 | 0.19 |
| Total B | 19.47 | 19.26 |
| Total | 100 | 100 |
| % expansion | 120 | 300 |
| Cold slam oiled G-60 | 2 | 10 |

### Example 4

Formulations in example 4 are prepared as those above.

Another material exhibiting efficacy in passing the cold slam test is an epoxidized polybutadiene (Poly BD 605E available from Cray Valley). Part A may include at least 5% or even at least 10% polybutadiene. Polybutadiene may be included as it tends to have a very low glass transition temperature, which allows it to be useful as a low temperature toughener. Polybutadiene is also somewhat oil-soluble, and this can be leveraged when the composition is applied to oily substrates. The epoxidized polybutadiene also improves extension at break. The epoxidized polybutadiene may be present in an amount of from about 5% to about 30% by weight of the adhesive in its entirety (both Part A and Part B). The epoxidized polybutadiene may be present in an amount of at least 8%, or even at least 12% by weight of the adhesive in its entirety. The effect of varying amounts of polybutadiene can be seen in the chart below:

| % by weight polybutadiene | Cold slam performance (10 = best) |
|---|---|
| on total formula | G-60 oiled with 61 MAL |
| 18.2 | 10 |
| 16.5 | 9 |
| 12.4 | 10 |
| 8.3 | 5 |

Table 4 shows formulas with and without Poly BD 605E and their performance in cold slam and extension to break in 3-point bend testing.

TABLE 4

| Part A Identification | 100 | 102 |
|---|---|---|
| KSE 3060 | 7.74 | 7.72 |
| YDF 170 | 5.13 | 5.11 |
| DEN 426 | 19.33 | 19.27 |
| Kane Ace MX-962 | 12.08 | 12.05 |
| Poly BD 605E | 0.00 | 14.42 |
| Q2 | 4.34 | 4.33 |
| Vansil HR2000 | 12.58 | 12.54 |
| Epotec YDM 441 | 3.82 | 3.80 |
| Garamite 1958 | 0.10 | 0.09 |
| total A | 79.59 | 79.34 |
| B Side | | |
| Part B Identification | 14-18 | 14-18 |
| PE-01 | 3.75 | 3.75 |
| PE-03 | 13.13 | 13.13 |
| Aerosil R208 | 0.56 | 0.56 |
| PA | 2.72 | 2.72 |
| Garamite 1958 | 0.24 | 0.24 |
| Total B | 20.41 | 20.41 |
| Total A + B | 100 | 100 |
| Thickness (mm) | 3.24 | 4 |
| Extension to break(mm) | 1.3 | 3.57 |
| Cold slam G-60 oiled | 2 | 10 |
| Load @ 2 mm | Na | 46.9 |

### Example 5

Formulations in example 5 are prepared as those above.

Reinforcing patches or adhesives need to provide sufficient stiffness to be of value as a stiffening material. Stiffness is measured using 3-point bend testing on an Instron tensile tester and evaluated at 2 mm of deflection. Results are reported as load at 2 mm in units of Newtons.

One factor influencing stiffness is the extent of expansion. Higher expanding formulations for instance higher than 150% provide less stiffness at 2 mm of deflection.

Expansion is achieved using a metal carbonate filler for example calcium carbonate, potassium carbonate, zinc carbonate, sodium bicarbonate, or some combination thereof.

Table 4 provides formulations in weight percentages along with their associated expansions, load at 2 mm and cold slam performance rating.

From table 5, system 23-4 with 150% expansion provided a reinforcing adhesive with the highest load at 2 mm, 63N.

TABLE 5

| Part A Identification | 23-4 | 23-5 | 23-8 |
|---|---|---|---|
| DER 331 | 8.73 | 8.73 | 9.11 |
| Epalloy 8250 | 19.21 | 19.21 | 20.04 |
| GE 60 | 10.48 | 10.48 | 10.93 |
| Kane Ace MX-257 | 11.65 | 11.65 | 12.15 |
| NC 514S | 2.73 | 2.73 | 2.85 |
| Epoxonic 328 Adduct | 1.75 | 1.75 | 1.82 |
| Q2 | | | 1.32 |
| KHCO₃ | | 9.4 | |
| Q 200 | 4.94 | 0.00 | 0.00 |
| TS 720 | 0.00 | 0.00 | 0.00 |
| Nyglos 8 | 18.21 | 18.21 | 19.00 |
| Vansil HR2000 | 0.00 | 0.00 | 0.00 |
| EpotecYDM 441 | 2.91 | 2.91 | 3.03 |
| Garamite 1958 | 0.31 | 0.31 | 0.32 |
| total A | 80.91 | 80.92 | 80.57 |
| B Side | | | |
| Part B Identification | 14-4 | 14-4 | 14-4 |
| PE-01 | 3.80 | 3.80 | 3.77 |
| PE-03 | 13.29 | 13.29 | 13.21 |
| PA | 2.28 | 2.28 | 2.26 |
| Garamite 1958 | 0.19 | 0.19 | 0.19 |
| Total B | 19.56 | 19.56 | 19.43 |
| Total wt % A + B | 100 | 100 | 100 |
| % Expansion | 150 | 400 | 280 |
| Load at 2 mm (N) | 63 | 22 | 54 |
| Cold slam oiled G-60 | 5 | 10 | 0 |

### Example 6

Formulations in example 6 are prepared as those above.

Another important formulation factor in achieving stiffness and flexibility is the amount of free phosphoric acid which is contained in the B-side.

If the acid percentage becomes too low, formulas become brittle and typically break before 2 mm of deflection.

Table 6 shows formulas with two percentages of free phosphoric acid and their corresponding load at 2 mm.

It can be seen from table 6 that the formula with higher amount of acid, 14-4 B-side formula has a higher load at 2 mm. The lower acid containing formula broke before reaching 2 mm. The free phosphoric acid may be present in an amount of from about 0.2% to about 5% by weight of the adhesive in its entirety (both Part A and Part B). The free phosphoric acid may be present in an amount of at least 1%, or even at least 2% by weight of the adhesive in its entirety.

TABLE 6

| Part A | 24-5 | 24-5 |
|---|---|---|
| DER 331 | 8.48 | 8.51 |
| Epalloy 8250 | 29.28 | 29.36 |
| GE 60 | 0.00 | 0.00 |
| Kane Ace MX-257 | 11.54 | 11.57 |
| NC 514S | 2.71 | 2.71 |
| Epoxonic 328 Adduct | 1.73 | 1.73 |
| Q 200 | 4.93 | 4.94 |
| Nyglos 8 | 18.06 | 18.10 |
| EpotecYDM 441 | 3.76 | 3.77 |
| Garamite 1958 | 0.25 | 0.25 |
| total A | 80.74 | 80.95 |
| B Side | | |
| Part B | 14-4 | 25-1 |
| PE-01 | 3.74 | 3.93 |
| PE-03 | 13.09 | 13.75 |
| PA | 2.24 | 1.18 |
| Garamite 1958 | 0.19 | 0.20 |
| Total B | 19.26 | 19.05 |
| Total A + B | 100 | 100 |
| Load at 2 mm (N) | 60 | Fail/break |

### Example 7

Reinforcing patches or adhesives need to maintain stiffness after exposure for example to humid environments. This is evaluated by placing substrate with applied and cured adhesive into humidity chambers for a period of time and rechecking stiffness (3-point bend test) (10 days 100° F./100% humidity—followed by one day recovery in a 54° C. oven). A rough indication of viability would result in an 80% retention of stiffness.

Retention of properties after humidity testing was achieved by the incorporation of a biphenyl aralkyl epoxy resin (KSE 360). Compared to conventional bis A or bis F-based epoxies, KSE 3060 has less oxygen content and no free hydroxyls. This results in a more hydrophobic structure, one that doesn't hydrogen bond with water. This structure affords better performance in humid environments than conventional epoxies. The biphenyl aralkyl epoxy resin may be present in an amount of at least about 5%, or even at least about 10%. The effect of the amount of biphenyl aralkyl epoxy resin can be seen in the chart below:

| % by wt. KSE | | | % retention |
|---|---|---|---|
| 3060 on total | % retention | % retention | extension |
| formula | 2 mm load | peak load | to break |
| 0 | 68 | 62 | 70 |
| 6.4 | 85 | 73 | 83 |
| 12.8 | 74 | 79 | 99 |

Table 7 provides formulations along with property retention percentages. Formulations that contain the biphenyl aralkyl epoxy retained a higher percentage of their original stiffness than those without. 60-4 coupon broke before reaching 2 mm of deflection after humidity exposure.

TABLE 7

| Part A Identification | 60-4 | 60-5 |
|---|---|---|
| YDF 170 | 0.00 | 8.54 |
| KSE 3060 | 0.00 | 12.82 |
| DEN 426 | 43.04 | 21.32 |
| Kane Ace MX-257 | 10.55 | 10.58 |
| Q 325 | 4.21 | 4.01 |
| Vansil HR2000 | 19.41 | 19.87 |
| EpotecYDM 441 | 3.53 | 3.46 |
| Garamite 1958 | 0.11 | 0.13 |
| total A | 80.84 | 80.71 |
| B Side | | |
| Part B | *9-2 | *9-2 |
| PE-01 | 3.52 | 3.55 |
| PE-03 | 12.33 | 12.41 |
| TS 720 | 0.53 | 0.53 |
| PA | 2.55 | 2.57 |
| Garamite 1958 | 0.23 | 0.23 |
| Total B | 19.16 | 19.29 |
| Total | 100.00 | 100.00 |
| Peak load retention | 65% | 81% |
| 2 mm load retention | na | 96% |

### Example 8

Another important attribute of reinforcing patches or adhesives is the desire to have low read through. Read though is a visual assessment of distortion caused by the stresses imparted on a substrate during the curing of the reinforcing material.

Testing read through consists of applying of the reinforcing adhesive, curing the material and visually assessing any distortion of the substrate. This assessment is enhanced by coating the opposite side of the substrate with a gloss black lacquer paint to aid in identifying the distortion.

Read through testing of various formulations indicates little or no distortion of the substrate. This is likely due to the nature of the curing process which first proceeds at room temperature and then finishes in the baking ovens. One component patches and one component pumpable reinforcing adhesives on the other hand cure entirely upon being exposed to the heat of baking ovens and once cooled, distort the substrate because a difference in the coefficient of thermal expansion between adhesive and substrate.

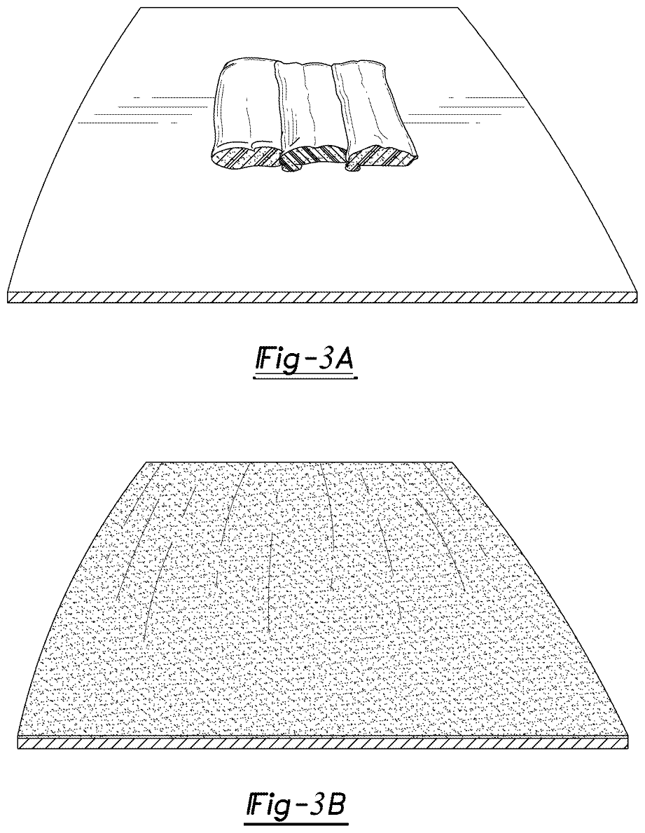

FIGS. 3A and 3B below provides an example of the reinforcing adhesive showing low read through. Shown is the adhesive on one side and the coated side exhibiting no distortion of a reflected image.

### Example 9

Another important attribute of reinforcing materials applied directly to steel is their ability to protect the substrate and resist corrosion. This property is tested in for instance a salt spray cabinet (ASTM B-117).

Table 8 contains a formulation that was applied to hot dip galvanized steel and cold rolled steel and exposed to 500 hours of salt spray.

FIGS. 5A and 5B (FIG. 5A hot dip galvanized); FIG. 5B (cold rolled steel) shows the exposed substrate with no evidence of rusting.

TABLE 8

| Part A | 23-15 |
|---|---|
| DER 331 | 8.63 |
| Epalloy 8250 | 18.99 |
| GE 60 | 10.36 |
| Kane Ace MX-257 | 11.51 |
| NC 514S | 2.70 |
| Epoxonic 328 Adduct | 1.73 |
| Q 200 | 4.88 |
| Nyglos 8 | 18.00 |
| EpotecYDM 441 | 3.76 |
| Garamite 1958 | 0.30 |
| total A | 80.88 |
| B Side | |
| Part B | 14-4 |
| PE-01 | 3.71 |
| PE-03 | 13.00 |
| PA | 2.23 |
| Garamite 1958 | 0.19 |
| Total B | 19.12 |
| Total A + B | 100 |

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time, and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist of, or consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A two-component liquid reinforcing adhesive comprising:
a. a first part A comprising:
i. at least one epoxide functional constituent;
ii. an optional foaming agent; and
iii. a reinforcing particulate;
b. a second part B comprising:
i. at least one acidic phosphorus containing curing agent.

2. The adhesive of claim 1, wherein the particulate filler has an aspect ratio of greater than 2.

3. The adhesive of claim 1, wherein the reinforcing particulate is selected from carbon black; precipitated silica; precipitated calcium carbonate; fumed silica; talc; clay such as kaolinite, montmorillonite, and sepiolite; micas such as phlogopite and muscovite; wollastonite; and mixtures thereof.

4. The adhesive of claim 3, wherein the content of the reinforcing particulate is greater than 30% by weight of the total liquid reinforcing adhesive formulation.

5. The adhesive of claim 4, wherein the at least one acidic phosphorus containing curing agent contains phosphoric acid.

6. The adhesive of claim 2, wherein the at least one epoxide functional constituent comprises a liquid epoxy resin, a reactive epoxy diluent, a multifunctional epoxy resin, or any mixture thereof.

7. The adhesive of claim 1, wherein the foaming agent is a metal carbonate.

8. The adhesive of claim 1, further including a toughening agent.

9. The adhesive of claim 8, wherein the toughening agent contains epoxidized rubber.

10. The adhesive of claim 4, wherein the adhesive when mixed and cured demonstrates low read through, adhesion to oiled steel, and continued adhesion when exposed to salt spray.

11-12. (canceled)

13. The adhesive of claim 1, including a polybutadiene component in an amount of at least 5% by weight.

14. The adhesive of claim 13, including a biphenyl aralkyl epoxy resin component in an amount of at least 5% by weight, or even at least 10% by weight.

15. The adhesive of claim 13, including a tetrafunctional epoxy resin.

16. The adhesive of claim 10, including calcium carbonate, potassium carbonate, zinc carbonate, sodium bicarbonate, or some combination thereof.

17. The adhesive of claim 1, including free phosphoric acid in an amount of at least 2% by weight.

18. The adhesive of claim 1, including at least two phosphate ester components.

19. The adhesive of claim 18, including an organophilic phyllosilicate-based component in both part A and part B.

20. (canceled)

21. The adhesive of claim 18, including one or more phosphate ester components selected from: a phosphate ester derived from cashew nutshell liquid (CNSL), a phosphate ester derived from 2-ethylhexyl glycidyl ether; a phosphate ester derived from phenyl glycidyl ether, a phosphate ester derived from an epoxidized para-tertiary butyl phenol, a nonyl phenol ethoxylated phosphate ester, or some combination thereof.

22. The adhesive of claim 1, including at least two phosphate ester components, a biphenyl aralkyl epoxy resin component, a polybutadiene component, and a tetrafunctional epoxy resin component.

23. The adhesive of claim 1 including at least two phosphate ester components, a biphenyl aralkyl epoxy resin component in an amount of at least 5% by weight, a polybutadiene component in an amount of at least 5% by weight, and a tetrafunctional epoxy resin component in an amount of at least 2%.

24-32. (canceled)
